(19) United States
(12) Patent Application Publication
(10) Pub. No.: US 2020/0180635 A1
(43) Pub. Date: Jun. 11, 2020

(54) APPARATUS FOR CONTROLLING DRIVING OF A VEHICLE, A SYSTEM HAVING THE SAME AND A METHOD THEREOF

(71) Applicants: HYUNDAI MOTOR COMPANY, Seoul (KR); KIA MOTORS CORPORATION, Seoul (KR)

(72) Inventor: Sung Ha Hong, Jeonju-si (KR)

(73) Assignees: HYUNDAI MOTOR COMPANY, Seoul (KR); KIA MOTORS CORPORATION, Seoul (KR)

(21) Appl. No.: 16/377,507

(22) Filed: Apr. 8, 2019

(30) Foreign Application Priority Data
Dec. 7, 2018 (KR) 10-2018-0157068

(51) Int. Cl. B60W 30/18; B62D 15/02; G05D 1/02; G08G 1/16

(52) U.S. Cl. CPC B60W 30/18163; B62D 15/024; B60W 2050/0005; G05D 1/0214; G08G 1/167; B62D 15/0255

(57) ABSTRACT

An apparatus for controlling driving of a vehicle, a system having the same, and a method thereof. The apparatus for controlling the driving of a vehicle includes a processor determining whether a lane change is necessary based on a rear situation of a reference vehicle when the lane change is necessary, determining whether the lane change is possible based on left-side and right-side rear situations of the reference vehicle, and performing lane change control depending on the determination result and a storage storing a result of the monitoring of the rear situation and the left-side and the right-side rear situations of the reference vehicle.

### CROSS-REFERENCE TO RELATED APPLICATION

This application claims the benefit of and priority to Korean Patent Application No. 10-2018-0157068, filed in the Korean Intellectual Property Office on Dec. 7, 2018, the entire contents of which are incorporated herein by reference.

### TECHNICAL FIELD

The present disclosure relates to an apparatus for controlling the driving of a vehicle, a system having the same, and a method thereof.

### BACKGROUND

With the development of vehicle technology, a driving assistance system for increasing the convenience of a user has been developed. A lane change support system is one example of such driving assistance systems. The known lane change support system identifies lane change intent of the user and determines whether a target vehicle is present in a lane to perform an automatic lane change.

In this way, the conventional lane change support system determines whether the lane change intent of the user is present only when the user turns on the turn signal or adjusts the steering angle and performs the automatic lane change. In other words, the conventional lane change support system performs the lane change depending on whether the user's manipulation is present without considering the user's intent of lane change. Accordingly, satisfying the needs of the user is difficult.

### SUMMARY

The present disclosure has been made to solve the above-mentioned problems occurring in the prior art while advantages achieved by the prior art are maintained intact.

An aspect of the present disclosure provides an apparatus for controlling the driving of a vehicle, a system having the same, and a method thereof that may actively determine the need for lane change through monitoring the rear lane monitoring and may automatically change a lane, in which a vehicle is driving.

The technical problems to be solved by the present disclosure are not limited to the aforementioned problems. Any other technical problems not mentioned herein will be clearly understood from the following description by those having ordinary skill in the art to which the present disclosure pertains.

According to an aspect of the present disclosure, an apparatus for controlling the driving of a vehicle may include a processor determining whether a lane change is necessary based on a rear situation of a reference vehicle when the lane change is necessary, determining whether the lane change is possible based on left-side and right-side rear situations of the reference vehicle, and performing lane change control depending on the determination result and a storage storing a result of monitoring the rear situation and the left-side and right-side rear situations of the reference vehicle.

According to an embodiment, the processor may be configured to monitor a forward situation of the reference vehicle to determine whether vehicle speed control is possible when the lane change is impossible and to perform the vehicle speed control of the reference vehicle.

According to an embodiment, the processor may be configured to determine that the lane change is necessary when at least one or more of a large vehicle, a high-speed approaching vehicle, and a vehicle blinking a head lamp are present behind the reference vehicle.

According to an embodiment, the processor may be configured to determine whether the lane change is necessary, depending on at least one or more of a relative distance of a large vehicle, a high-speed approaching vehicle, and a vehicle blinking a head lamp, which are present behind the reference vehicle, a relative speed of the large vehicle, the high-speed approaching vehicle, and the vehicle blinking the head lamp and whether the large vehicle, the high-speed approaching vehicle, and the vehicle blinking the head lamp blink a turn signal.

According to an embodiment, the processor may be configured to determine whether the lane change is possible, depending on whether there is a rear vehicle driving in a rear left lane of the reference vehicle or a rear right lane of the reference vehicle.

According to an embodiment, the processor may be configured to determine a lane in which the reference vehicle is driving.

According to an embodiment, the processor may be configured to determine whether the lane change to a right lane is possible when the reference vehicle is driving in a passing lane and to perform the lane change to the right lane when the lane change to the right lane is possible.

According to an embodiment, when it is impossible for the reference vehicle to change to the right lane, the processor may be configured to monitor a forward situation of the reference vehicle to determine whether an increase in a vehicle speed is possible when the rear vehicle is a large vehicle.

According to an embodiment, the processor may be configured to determine that the increase in the vehicle speed is possible in at least one or more instances. For example, speed increase may be possible where there is no front vehicle in front of the reference vehicle, where the front vehicle is present but a relative speed and a relative distance of the front vehicle satisfy a reference condition, or where the front vehicle is present but the front vehicle does not have an intent of the lane change to the lane of the reference vehicle.

According to an embodiment, when it is impossible for the reference vehicle to change to the right lane, the processor may be configured to allow a current speed and a current lane to be maintained when the rear vehicle is a high-speed approaching vehicle or a vehicle blinking a head lamp.

According to an embodiment, when the reference vehicle is driving on a slow lane among a plurality of lanes, the processor may be configured to determine that the lane change is necessary when there is a large vehicle behind in the lane on which the reference vehicle is driving or when a relative speed or a relative distance of the large vehicle satisfies a predetermined condition and there is no blink of a turn signal.

According to an embodiment, the processor may be configured to determine whether a change to a left lane is possible when the lane change is necessary and to determine whether to increase a vehicle speed when the change to the left lane is impossible.

According to an embodiment, when the reference vehicle is driving in a middle lane among a plurality of lanes, the processor may be configured to determine whether the lane change to a right lane is possible and to determine whether an increase in a vehicle speed is possible when the lane change to the right lane is not possible.

According to an embodiment, after controlling the lane change, the processor may be configured to monitor a forward situation and the rear situation in the changed lane to perform return control to a previous lane.

According to another aspect of the present disclosure, a vehicle system may include a vehicle driving control apparatus configured to: determine whether a lane change is necessary, based on a rear situation of a reference vehicle, when the lane change is necessary; determine whether the lane change is possible, based on left-side and right-side rear situations of the reference vehicle; and perform lane change control depending on the determination result and a sensing module sensing a surrounding situation of the reference vehicle to transmit the sensing result to the vehicle driving control apparatus.

According to an aspect of the present disclosure, a method for controlling a driving of a vehicle may include monitoring a rear situation of a driving reference vehicle, which is driving, to determine whether a lane change is necessary, when the lane change is necessary, and monitoring left-side and right-side rear situations of the reference vehicle to determine whether the lane change is possible, and when the lane change is possible, performing lane change control.

According to an embodiment, the method may further include monitoring a forward situation of the reference vehicle to determine whether vehicle speed control is possible when the lane change is impossible and performing the vehicle speed control of the reference vehicle when the vehicle speed control is possible.

According to an embodiment, the method may further include monitoring a forward situation and the rear situation in a changed lane to perform return control to a previous lane after controlling the lane change.

According to an embodiment, the determining of whether the lane change is necessary may include determining that the lane change is necessary when at least one or more of a large vehicle, a high-speed approaching vehicle, and a vehicle blinking a head lamp are present behind the reference vehicle.

According to an embodiment, the determining of whether the lane change is necessary may include determining whether the lane change is necessary, depending on at least one or more of a relative distance of a large vehicle, a high-speed approaching vehicle, and a vehicle blinking a head lamp, which are present behind the reference vehicle. The determining whether the lane change is necessary may include determining whether the lane change is necessary, depending on a relative speed of the large vehicle, the high-speed approaching vehicle, and the vehicle blinking the head lamp, and whether the large vehicle, the high-speed approaching vehicle, and the vehicle blinking the head lamp blinks a turn signal.

### BRIEF DESCRIPTION OF THE DRAWINGS

The above and other objects, features, and advantages of the present disclosure will be more apparent from the following detailed description taken in conjunction with the accompanying drawings:

FIG. 1 is a block diagram illustrating a configuration of a vehicle system including a vehicle driving control apparatus, according to an embodiment of the present disclosure;

FIG. 2 is a view for describing an operation of a monitoring area and lane change control for controlling the driving of a vehicle, according to an embodiment of the present disclosure;

FIG. 3 is a flowchart for describing a method for controlling the driving of a vehicle, according to an embodiment of the present disclosure;

FIG. 4 is a flowchart for describing a method for controlling the driving when the reference vehicle is driving on the leftmost lane, according to an embodiment of the present disclosure;

FIG. 5 is a flowchart for describing a method for controlling the driving when the reference vehicle is driving on the rightmost lane, according to an embodiment of the present disclosure;

FIG. 6 is a flowchart for describing a method for controlling the driving when the reference vehicle is driving on a middle lane, according to an embodiment of the present disclosure;

FIG. 7 is a view for describing an operation to control an automatic lane change to a left lane when a lane change is necessary upon driving a middle lane, according to an embodiment of the present disclosure;

FIG. 8 is a view for describing an operation to control a vehicle speed when it is impossible to change the current lane to a left lane and a right lane when a lane change is necessary upon driving a middle lane, according to an embodiment of the present disclosure;

FIG. 9 is a view for describing an operation to control an automatic lane change when a rear vehicle is approaching with a head lamp blinking while driving a passing lane, according to an embodiment of the present disclosure;

FIG. 10 is a view for describing an operation to control an automatic lane change when a rear vehicle is approaching at high speed while driving a passing lane, according to an embodiment of the present disclosure; and

FIG. 11 illustrates a computing system according to an embodiment of the present disclosure.

### DETAILED DESCRIPTION

Hereinafter, embodiments of the present disclosure are described in detail with reference to the accompanying drawings. In the drawings, the same reference numerals are used throughout to designate the same or equivalent elements. In addition, a detailed description of well-known features or functions is excluded in order to not unnecessarily obscure the gist of the present disclosure.

In describing elements of embodiments of the present disclosure, the terms first, second, A, B, (a), (b), and the like may be used herein. These terms are only used to distinguish one element from another element but do not limit the corresponding elements irrespective of the order or priority of the corresponding elements. Furthermore, unless otherwise defined, all terms including technical and scientific terms used herein are to be interpreted as is customary in the art to which this disclosure belongs. It will be understood that terms used herein should be interpreted as having a meaning that is consistent with their meaning in the context of the present disclosure and the relevant art and will not be interpreted in an idealized or overly formal sense unless expressly so defined herein.

A user usually wants to change a lane for the purpose of avoiding a rear vehicle when a large vehicle (e.g., a commercial vehicle such as a heavy duty truck, a bus, or the like) is driving behind a host vehicle when there is a vehicle approaching from the rear at high speed or when the rear vehicle is driving while blinking a head lamp. The user takes action, such as changing the lane by performing intervention, for example, pressing an accelerator pedal, turning on a turn signal, or changing the steering angle of the steering wheel, when recognizing the above-mentioned situation upon performing the driving assist function.

The present disclosure may disclose a configuration in which a vehicle system actively determines a rear situation to determine a situation where an automatic lane change is necessary when the rear situation reach a specific condition and comprehensively determines traffic conditions of left and right lanes to perform the automatic lane change before the user performs the intervention (e.g., turning on the turn signal or changing the steering angle of the steering wheel).

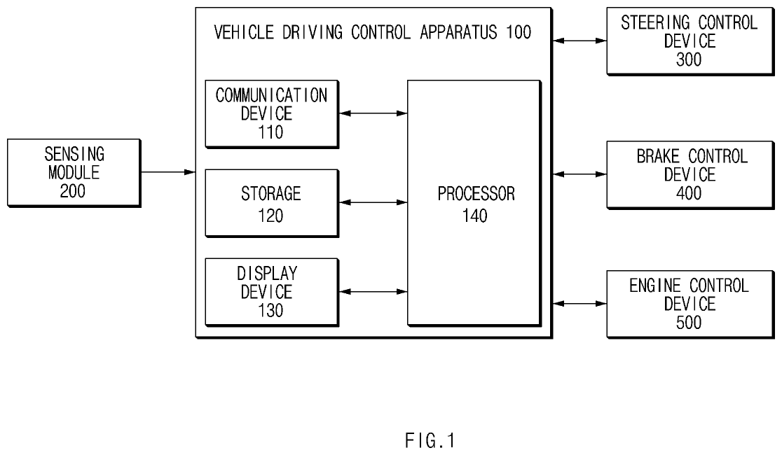

Below, various embodiments of the present disclosure are described in detail with reference to FIGS. 1 to 11.

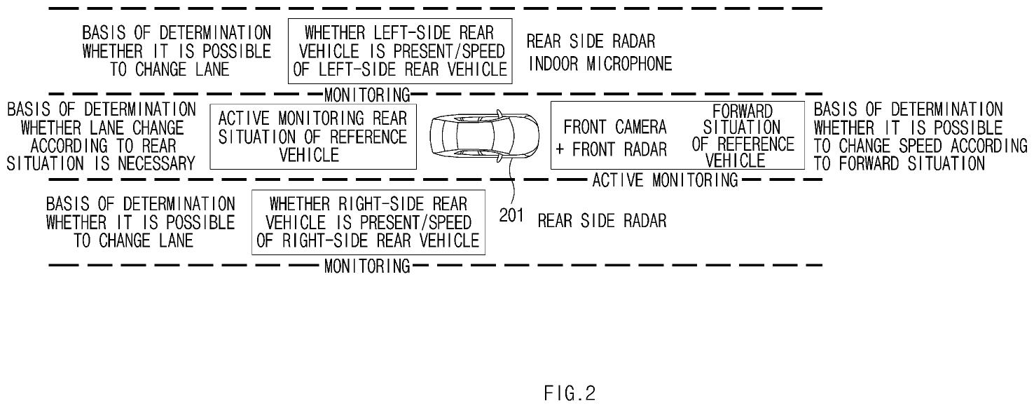

FIG. 1 is a block diagram illustrating a configuration of a vehicle system including a vehicle driving control apparatus, according to an embodiment of the present disclosure. FIG. 2 is a view for describing an operation of a monitoring area and lane change control for controlling the driving of a vehicle, according to an embodiment of the present disclosure.

Referring to FIG. 1, a vehicle system according to an embodiment of the present disclosure may include a vehicle driving control apparatus 100, a sensing module 200, a steering control device 300, a brake control device 400, and an engine control device 500.

The vehicle driving control apparatus 100 may determine whether a lane change is necessary by monitoring a rear situation of a reference vehicle (i.e., a host vehicle) currently driving. When determining whether the lane change is necessary, the vehicle driving control apparatus 100 may monitor a left-side or right-side rear situation of the reference vehicle, may determine whether the lane change is necessary, and may perform lane change control. The vehicle driving control apparatus 100 may perform return control to the previous lane. Moreover, the vehicle driving control apparatus 100 may monitor the forward condition of a reference vehicle to determine whether it is possible to control a vehicle speed and may perform the speed of the reference vehicle when the lane change is impossible.

The vehicle driving control apparatus 100 may include a communication device 110, storage 120, a display device 130, and a processor 140.

The communication device 110 may be a hardware device implemented with various electronic circuits for transmitting and receiving signals via a wireless or wired connection. In the present disclosure, the communication device 110 may perform in-vehicle communication over CAN communication, LIN communication, or the like and may communicate with the sensing module 200, the steering control device 300, the brake control device 400, the engine control device 500, or the like.

The storage 120 may store the sensing result of the sensing module 200, information determined by the processor 140, and the like. The storage 120 may include at least one type of a storage medium among a flash memory type of a memory, a hard disk type of a memory, a micro type of a memory, and a card type (e.g., a Secure Digital (SD) card or an eXtream Digital (XD) Card) of a memory), a Random Access Memory (RAM) type of a memory, a Static RAM (SRAM) type of a memory, a Read-Only Memory (ROM) type of a memory, a Programmable ROM (PROM) type of a memory, an Electrically Erasable PROM (EEPROM) type of a memory, a Magnetic RAM (MRAM) type of a memory, a magnetic disk type of a memory, and an optical disc type of a memory.

The display device 130 may display the result determined by processor 140. That is, a situation where the lane change is necessary, a situation where a lane is changed, a situation where a speed is controlled, or the like, may be displayed to notify a user of the result. The display device 130 may be implemented with a Head Up Display (HUD), a cluster, an Audio Video Navigation (AVN), or the like. In addition, the display device 130 may directly receive a color input from a user through a User Setting Menu (USM) menu of a cluster. Furthermore, the display device 130 may include at least one of a Liquid Crystal Display (LCD), a Thin Film Transistor-LCD (TFT LCD), a Light Emitting Diode (LED) display, an Organic LED (OLED) display, an Active Matrix OLED (AMOLED) display, a flexible display, a bended display, and a 3D display. Some of the displays may be implemented with a transparent display that is transparent or optically transparent to view the outside. Moreover, the display device 130 may be provided as a touchscreen, including a touch panel, and may be used as an input device in addition to an output device.

The processor 140 may be electrically connected to the communication device 110, the storage 120, the display device 130, or the like, may electrically control each of the components, may be an electrical circuit that executes the instructions of the software, and may perform various data processing and calculation described below.

The processor 140 may determine whether the lane change is necessary by monitoring a rear situation of a reference vehicle currently driving. When determining whether the lane change is necessary, the processor 140 may monitor a left-side or right-side rear (rear side) situation of the reference vehicle, may determine whether the lane change is necessary, and may perform lane change control. After the lane change is completed, the processor 140 may perform return control to the previous lane by monitoring a surrounding situation.

The processor 140 may monitor the forward situation of a reference vehicle to determine whether it is possible to control a vehicle speed and may perform the speed of the reference vehicle, when the lane change is impossible.

The processor 140 may determine that the lane change is necessary when at least one of a large vehicle, a vehicle approaching from the rear at high speed, or a vehicle driving while blinking a head lamp is present behind the reference vehicle. The processor 140 may determine whether a lane change is necessary, based on at least one or more of: the relative distance of the large vehicle, the high-speed approaching vehicle, or the vehicle blinking a head lamp; the relative vehicle speed of the large vehicle, the high-speed approaching vehicle, or the vehicle blinking a head lamp and whether the large vehicle, the high-speed approaching vehicle, or the vehicle blinking a head lamp blink a turn signal. The processor 140 may determine whether a lane change is necessary using image data of the rear camera of the sensing module 200.

That is, the processor 140 determines that the lane change is necessary when there is a large vehicle behind the reference vehicle or when the large vehicle is placed within a predetermined distance from the reference vehicle, when the relative speed of the large vehicle is not greater than a predetermined speed, and when there is no intent of a lane change.

Furthermore, the processor 140 determines that the lane change is necessary when there is a rear vehicle blinking a head lamp behind the reference vehicle, when there is a rear vehicle approaching at high-speed, or when the relative speed of a high-speed approaching vehicle is not greater than a predetermined speed and there is no intent of a lane change.

The processor 140 monitors the lateral rear situation to determine a lane to be changed when it is determined that a lane change is necessary. The processor 140 may determine whether a lane change is possible depending on whether there is a rear vehicle that is driving on a left-side rear lane or a right-side rear lane of the reference vehicle. At this time, the processor 140 may determine whether the lane change is possible by sensing the situation of a rear side vehicle (e.g., whether there is an approaching vehicle, a relative distance based on a reference vehicle, a relative vehicle speed, or the like) by using the rear side radar of the sensing module 200.

The processor 140 may determine the lane on which the reference vehicle is driving using the image data of the front camera of the sensing module 200.

The processor 140 may determine whether it is possible to change the current lane to the right lane when the reference vehicle is driving on a passing lane. The processor 140 may perform a lane change to the right lane, when it is possible to change the current lane to the right lane.

The processor 140 may determine whether the increase in a vehicle speed is possible by monitoring the forward situation of the reference vehicle when the reference vehicle is not capable of changing the current lane to the right lane and when a rear vehicle is a large vehicle. The processor 140 may monitor a forward situation (e.g., whether there is a front vehicle, a relative distance based on a reference vehicle, a relative speed, or the like) by using the front camera and the front radar of the sensing module 200 and may determine whether to increase a vehicle speed.

The processor 140 may determine that the increase in a vehicle speed is possible in at least one or more situations. For example, the processor 140 may determine that the increase in vehicle speed is possible where there is no front vehicle in front of of a reference vehicle, where the front vehicle is present but the relative speed and the relative distance of the front vehicle satisfy a reference condition, or where the front vehicle is present but the front vehicle does not intend to change the lane to the lane of the reference vehicle.

The processor 140 may control the reference vehicle to maintain a current speed and a current lane when the reference vehicle is not capable of changing the lane to the right lane and when a rear vehicle is a high-speed approaching vehicle or a vehicle blinking a head lamp. A high-speed approaching vehicle or a vehicle blinking a head lamp may be a vehicle in an emergency, such as an emergency vehicle. Because there is a risk of accident when a vehicle is approaching at high speed, the processor 140 may control the reference vehicle to maintain the current speed and current lane without changing to the left lane.

The processor 140 may determine that the lane change is necessary when the reference vehicle is driving in a slow lane among a plurality of lanes and when there is a large vehicle behind the reference vehicle in the lane in which the reference vehicle is driving, when the relative speed or the relative distance of the large vehicle satisfies a predetermined condition, and when there is no blink of a turn signal. The processor 140 may determine whether it is possible to change the current lane to the left lane when the lane change is necessary. The processor 140 may determine whether to increase a vehicle speed when it is impossible to change the current lane to the left lane. When the reference vehicle is driving in a middle lane among a plurality of lanes, the processor 140 may determine whether it is possible to change the current lane to the right lane. The processor 140 may determine whether it is possible to change the current lane to the left lane when it is impossible to change the current lane to the right lane. The processor 140 may determine whether to increase a vehicle speed when it is impossible to change the current lane to the left lane.

Referring to FIG. 2, the processor 140 may actively monitor a rear situation through a rear camera based on a reference vehicle 201, may monitor whether there is a side vehicle and a speed, using a rear side radar, of the side vehicle, and may actively monitor a forward situation through a front camera and a front radar.

The processor 140 may determine whether the lane change is necessary using the result of monitoring the rear situation of the reference vehicle. The processor 140 may determine whether it is possible to change a vehicle speed using the result of monitoring the forward situation of the reference vehicle. The processor 140 may determine whether it is possible to change a lane using the lateral rearward monitoring result.

The sensing module 200 may include a plurality of sensors for sensing an object outside the vehicle and may obtain information about the location of an external object (e.g., the front, rear, side, and side rear of the reference vehicle), the speed of the external object, the movement direction and/or the type of the external object (e.g., a vehicle, a pedestrian, a bicycle, a motorcycle, or the like). To this end, the sensing module 200 may include a radar, a camera, an ultrasonic sensor, a laser scanner and/or a corner radar, a LiDAR, an acceleration sensor, a yaw rate sensor, a torque measurement sensor and/or a wheel speed sensor, or the like. In the present disclosure, the sensing module 200 may sense the relative speed and relative distance of the vehicle around a vehicle by mounting the radar and camera on the front, rear, and side of the vehicle.

The steering control device 300 may be configured to control the steering angle of the vehicle and may include a steering wheel, an actuator operating in conjunction with the steering wheel, and a controller for controlling the actuator.

The brake control device 400 may be configured to control the brake of the vehicle and may include a controller for controlling the brake.

The engine control device 500 may be configured to control driving of the engine of a vehicle and may include a controller for controlling the speed of the vehicle.

As such, the present disclosure may actively determine whether the lane change is necessary by monitoring a rear situation and may determine whether it is possible to change a lane in consideration of side rear situation information to perform lane change control. The automatic lane change may be performed by determining whether the lane change is necessary when a large vehicle (e.g., a heavy lorry, a heavy duty truck, or a heavy duty bus) is driving within a specific distance, when a rear vehicle on a passing lane is blinking a head lamp, or when there is a vehicle (e.g., an emergency vehicle) approaching the rear of the passing lane at high speed in the rear situation.

That is, in the present disclosure, a vehicle system may actively determine a rear situation to determine a situation where an automatic lane change is necessary when the rear situation reaches a specific condition and may comprehensively determine traffic conditions of left and right lanes to perform the automatic lane change without the intervention of the user (e.g., a driver turning on a turn signal or changing the steering angle of the steering wheel).

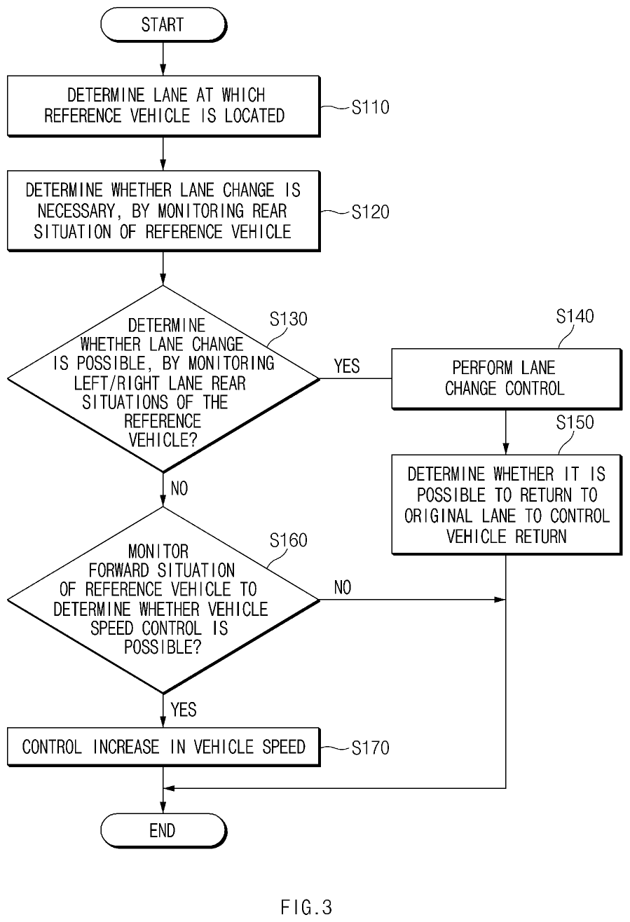

Below, a vehicle driving controlling method according to each situation is described in detail with reference to FIGS. 3 to 6. Below, it is assumed that the apparatus 100 of FIG. 1 performs a process of FIGS. 3 to 6. In addition, as described in FIGS. 3 to 6, it is understood that the operation described as being executed by the apparatus 100 is controlled by the processor 140 of the apparatus 100.

Hereinafter, according to an embodiment of the present disclosure, a method for controlling the driving of a vehicle is described in detail with reference to FIG. 3. FIG. 3 is a flowchart for describing a method for controlling the driving of a vehicle, according to an embodiment of the present disclosure.

In operation S110, the vehicle driving control apparatus 100 may determine whether a lane on which a reference vehicle (i.e., a host vehicle) is driving is a first lane (e.g., a passing lane or a leftmost lane), a second lane (e.g., a middle lane), or a third lane (e.g., a slow lane or a rightmost lane)

In operation S120, the vehicle driving control apparatus 100 determines whether a lane change is necessary by monitoring a rear situation of the reference vehicle. The vehicle driving control apparatus 100 may determine whether a heavy duty truck or a bus is driving behind the reference vehicle, whether there is a high-speed approaching vehicle, or whether there is a vehicle that is driving while blinking a head lamp. The vehicle driving control apparatus 100 may determine that the lane change is necessary when at least one or more vehicles are behind the reference vehicle.

In operation S130, the vehicle driving control apparatus 100 may determine whether a lane change is possible by monitoring left/right lane rear situations of the reference vehicle when it is determined that the lane change is necessary. That is, the vehicle driving control apparatus 100 may determine whether there is a vehicle on the left/right lanes behind the reference vehicle through a rear-side camera and a rear-side radar. The vehicle driving control apparatus 100 may determine whether the lane change is possible by determining the approach speed and the relative distance of the vehicle when the vehicle is present.

In operation S140, the vehicle driving control apparatus 100 may perform lane change control when it is possible to change the current lane to the left lane or the right lane. After the lane change control is completed, the vehicle driving control apparatus 100 determines whether it is possible to return to a previous lane (original lane) in operation S150. When possible, the vehicle driving control apparatus 100 may control the lane change to the previous lane. The vehicle driving control apparatus 100 may determine whether there is a rear vehicle through a rear-side camera and a rear-side radar, may determine whether there is a front vehicle through a front camera and a front radar, or may calculate a relative distance or a relative speed between a surrounding vehicle and the reference vehicle. The vehicle driving control apparatus 100 may perform return control to the previous lane when the relative distance and the relative speed conditions are satisfied.

On the other hand, in operation S160, the vehicle driving control apparatus 100 may monitor the forward situation of the reference vehicle to determine whether vehicle speed control is possible when it is impossible to change the current lane to the left lane or the right lane. That is, the vehicle driving control apparatus 100 may control the vehicle speed without controlling the lane change when the lane change is impossible because vehicles driving on the left lane and/or the right lane are present or when there is a vehicle in front and the lane change is impossible depending on the condition of a relative speed and a relative distance of the front vehicle.

In operation S170, the vehicle driving control apparatus 100 determines that the increase in a speed is possible and increases the vehicle speed of the reference vehicle when there is no front vehicle or when the condition of the relative speed and the relative distance between the front vehicle and the reference vehicle is satisfied.

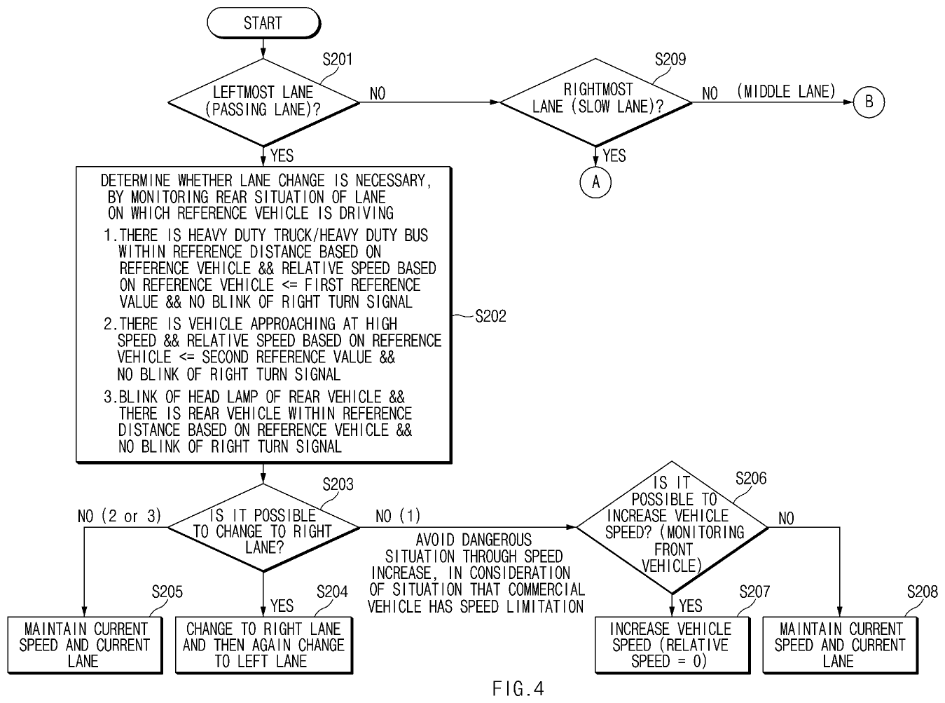

Hereinafter, according to an embodiment of the present disclosure, a method for controlling the driving when the reference vehicle is driving on the leftmost lane is described in detail with reference to FIG. 4. FIG. 4 is a flowchart for describing a method for controlling the driving when the reference vehicle is driving on the leftmost lane, according to an embodiment of the present disclosure.

In operation S201, the vehicle driving control apparatus 100 determines whether a lane on which the reference vehicle is currently driving is the leftmost lane (e.g., a passing lane or a first lane).

In operation S202, the vehicle driving control apparatus 100 determines whether a lane change is necessary by monitoring the rear situation of a lane on which the reference vehicle is driving when the reference vehicle is currently driving on the leftmost lane.

First, the vehicle driving control apparatus 100 may determine whether the lane change is necessary by determining whether there is a heavy duty truck or a heavy duty bus behind a vehicle, whether the heavy duty truck or the heavy duty bus is present within a reference distance from the reference vehicle, whether a relative speed between the reference vehicle and the heavy duty truck or the heavy duty bus is not less than a first reference value, whether a right turn signal of the heavy duty truck or the heavy duty bus is blinking, or the like. That is, the vehicle driving control apparatus 100 may determine that the lane change is necessary when the heavy duty truck or the heavy duty bus is present within a reference distance from the reference vehicle, when the relative speed between the reference vehicle and the heavy duty truck or the heavy duty bus is not less than the first reference value, or when the heavy duty truck or the heavy duty bus does not blink a right turn signal. For example, the reference distance may be set to 20 m, and the first reference value may be set to 1 km/h.

Second, the vehicle driving control apparatus 100 may determine whether the lane change is necessary in consideration of whether there is a vehicle approaching from the rear of the reference vehicle at high speed, whether the relative speed between a high-speed approaching vehicle and the reference vehicle is not greater than a second reference value, whether the high-speed approaching vehicle blinks a right turn signal, or the like. That is, the vehicle driving control apparatus 100 may determine that the lane change is necessary when there is a vehicle approaching from the rear of the reference vehicle at high speed, when the relative speed between a high-speed approaching vehicle and the reference vehicle is not greater than a second reference value, and when the high-speed approaching vehicle does not blink a right turn signal. For example, the second reference value may be set to −7 km/h.

Third, the vehicle driving control apparatus 100 may determine whether the lane change is necessary through determining whether a rear vehicle blinks a head lamp upwardly, whether the rear vehicle is present within a reference distance from the reference vehicle, whether the rear vehicle does not blink a right turn signal, or the like. That is, the vehicle driving control apparatus 100 may determine that the lane change is necessary when a rear vehicle blinks a head lamp upwardly, when the rear vehicle is present within the reference distance from the reference vehicle, and when the rear vehicle does not blink a right turn signal.

In operation S203, the vehicle driving control apparatus 100 determines whether it is possible to change the current lane to the right lane, because the current lane is the leftmost lane, when it is determined that the lane change is necessary due to at least one of the three cases described above.

The vehicle driving control apparatus 100 may determine whether it is possible to change the current lane to the right lane when there is no vehicle is driving behind the right lane or when the relative speed and relative distance of the vehicle that is driving behind the right lane satisfy a predetermined reference condition.

In operation S204, the vehicle driving control apparatus 100 may perform right lane change control and then may perform return control to the previous lane (the left lane) when it is possible to change the current lane to the right lane.

In operation S205, the vehicle driving control apparatus 100 may control the vehicle to maintain a current speed and the current lane when it is impossible to change the current lane to the right lane in a state where there is a high-speed approaching vehicle behind the reference vehicle or the rear vehicle is driving while blinking a head lamp in operation S202.

In operation S206, the vehicle driving control apparatus 100 determines whether it is possible to increase the speed of the reference vehicle when it is impossible to change the current lane to the right lane in a state where a heavy duty truck or a heavy duty bus is driving behind the reference vehicle in operation S202. The vehicle driving control apparatus 100 may determine whether it is possible to increase a vehicle speed by determining whether there is a front vehicle, the relative speed and the relative distance of the front vehicle, the intent of a lane change of the front vehicle, or the like. For example, the vehicle driving control apparatus 100 may stop the control of a speed increase by determining that the intent of a lane change is present when a front vehicle on a left lane or a right lane of a lane in which the reference vehicle is driving blinks a turn signal. That is, the vehicle driving control apparatus 100 may stop the control of a speed increase of the reference vehicle when the front vehicle on the left lane or the right lane blinks a turn signal to change the current lane to the lane in which the reference vehicle is driving.

As such, in operation S207, the vehicle driving control apparatus 100 may control the reference vehicle to increase the speed of the reference vehicle when it is possible to increase the speed of the reference vehicle. In operation S208, the vehicle driving control apparatus 100 may control the reference vehicle to maintain the current speed and the current driving lane of the reference vehicle when it is impossible to increase the speed of the reference vehicle.

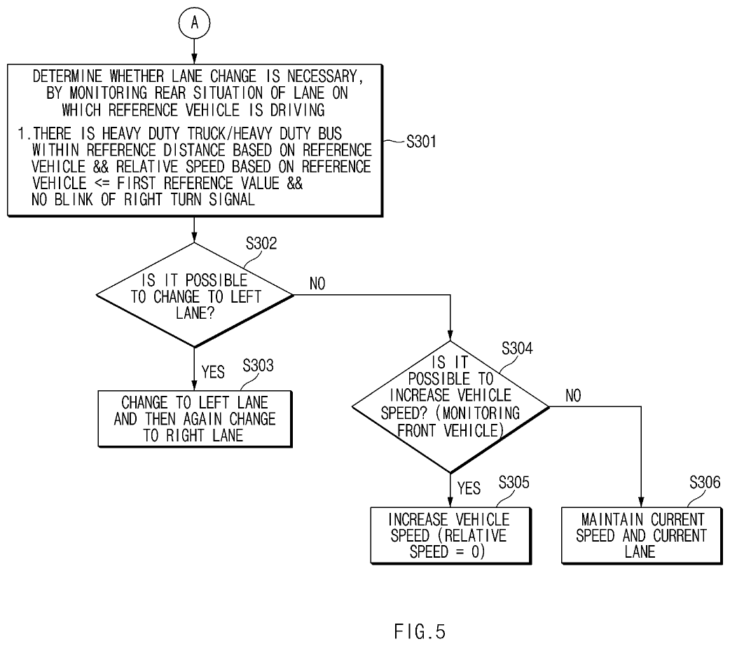

Hereinafter, according to an embodiment of the present disclosure, a method for controlling the driving when the reference vehicle is driving on the rightmost lane is described in detail with reference to FIG. 5. FIG. 5 is a flowchart for describing a method for controlling the driving when the reference vehicle is driving on the rightmost lane, according to an embodiment of the present disclosure.

FIG. 5 illustrates a method of controlling a lane change when a reference vehicle is driving on the rightmost lane (e.g., a slow lane) (A) in operation S209 of FIG. 4.

In operation S301, the vehicle driving control apparatus 100 determines whether a lane change is necessary by monitoring a rear situation of a lane in which the reference vehicle is driving.

That is, the vehicle driving control apparatus 100 may determine whether a heavy duty truck or a heavy duty bus is driving behind the lane (e.g., the rightmost lane) on which the reference vehicle is driving. The vehicle driving control apparatus 100 may determine whether a lane change is necessary by determining whether the heavy duty truck or the heavy duty bus is present within a reference distance from the reference vehicle, whether the relative speed of the heavy duty truck or the heavy duty bus is not greater than a predetermined reference value (e.g., −1 km/h) based on the reference vehicle, whether the heavy duty truck or the heavy duty bus blinks a left turn signal, or the like. The vehicle driving control apparatus 100 may determine that the lane change is necessary when the heavy duty truck or the heavy duty bus is present behind the reference vehicle within the reference distance from the reference vehicle, when the relative speed of the heavy duty truck or the heavy duty bus is not greater than −1 km/h based on the reference vehicle, and when the heavy duty truck or the heavy duty bus do not blink the left turn signal.

In operation S302, the vehicle driving control apparatus 100 determines whether it is possible to change the current lane to the left lane, because the reference vehicle is driving in the rightmost lane, when the lane change is necessary.

In operation S303, the vehicle driving control apparatus 100 may perform left lane change control when it is possible to change the current lane to the left lane. The vehicle driving control apparatus 100 may perform return control to the right lane when a return control condition to the right lane being the previous lane is satisfied.

In operation S304, the vehicle driving control apparatus 100 may determine whether it is possible to increase a vehicle speed by monitoring the forward situation of a lane on which the reference vehicle is driving when it is impossible to change the current lane to the left lane. The vehicle driving control apparatus 100 may determine that it is possible to increase a vehicle speed when there is no vehicle in front, when the relative speed of the front vehicle is not less than a reference value even though the front vehicle is present, when the relative distance is not less than a predetermined reference distance (e.g., 30 m), and when a front vehicle driving on a left lane or a right lane in front of the reference vehicle does not attempt to change the current lane to a lane in which the reference vehicle is driving (e.g., whether the front vehicle blinks a turn signal).

In operation S305, the vehicle driving control apparatus 100 may control the reference vehicle to increase the speed of the reference vehicle when it is possible to increase a vehicle speed.

On the other hand, in operation S306, the vehicle driving control apparatus 100 may control the reference vehicle to maintain the current speed and the current lane when it is impossible to increase a vehicle speed.

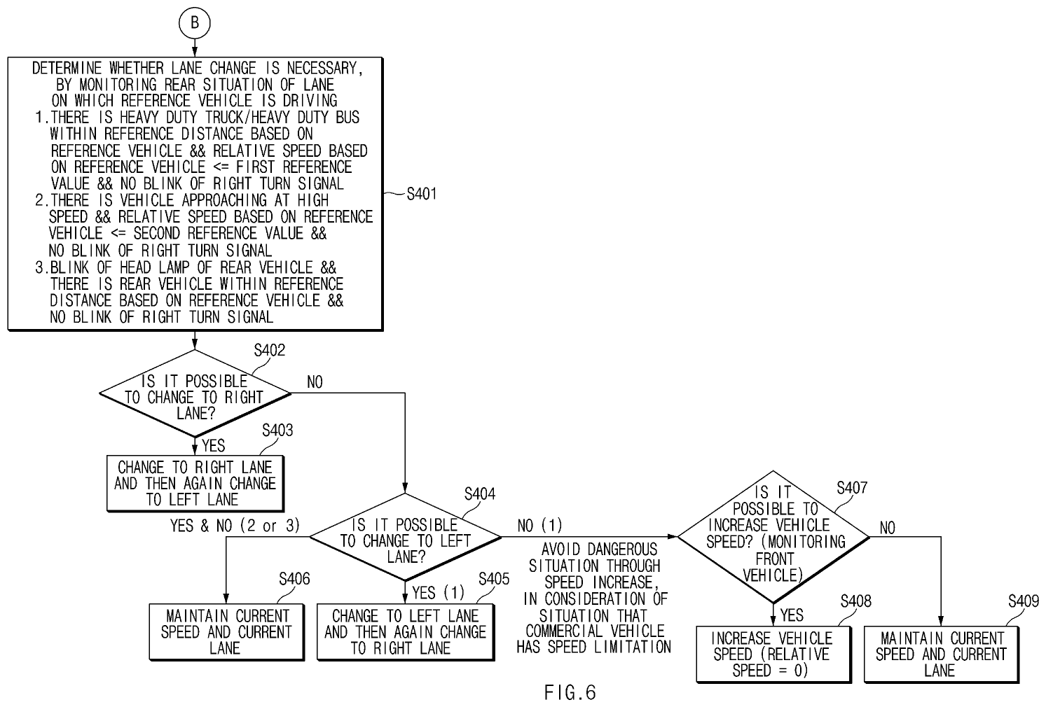

Hereinafter, according to an embodiment of the present disclosure, a method for controlling the driving when the reference vehicle is driving in a middle lane is described in detail with reference to FIG. 6. FIG. 6 is a flowchart for describing a method for controlling the driving when the reference vehicle is driving in a middle lane. FIG. 6 illustrates a method of controlling a lane change when a reference vehicle is driving in a middle lane (B) in operation S209 of FIG. 4.

In operation S401, the vehicle driving control apparatus 100 determines whether a lane change is necessary by monitoring a rear situation of a lane in which the reference vehicle is driving.

As illustrated in operation S202 of FIG. 4, the vehicle driving control apparatus 100 determines whether a lane change is necessary depending on whether there is a heavy duty truck or a heavy duty bus behind a lane in which the reference vehicle is driving, whether there is a high-speed approaching vehicle, whether there is a rear vehicle blinking a head lamp, the locations of rear vehicles, the relative speeds of the rear vehicles, whether the rear vehicles blink a right turn signal, or the like. Because the specific feature for determining whether a lane change is necessary is the same as the description in operation S202 of FIG. 4, the description of the specific condition is not repeated here.

In operation S402, the vehicle driving control apparatus 100 determines whether it is possible to change the current lane to the right lane first, because the current lane is a middle lane, when it is determined that the lane change is necessary. The vehicle driving control apparatus 100 may determine that it is possible to change the current lane to the right lane when there is no vehicle driving behind on the right lane or when the relative speed and the relative distance of the vehicle driving behind in the right lane satisfy a predetermined reference condition.

In operation S403, the vehicle driving control apparatus 100 may perform right lane change control and then may perform return control to the previous lane (e.g., the left lane) when it is possible to change the current lane to the right lane.

In operation S404, the vehicle driving control apparatus 100 may determine whether it is possible to change the current lane to the left lane when it is impossible to change the current lane to the right lane.

In operation S405, the vehicle driving control apparatus 100 may perform left lane change control and then may perform return control to the previous lane (e.g., the right lane), when it is possible to change the current lane to the left lane.

In operation S406, the vehicle driving control apparatus 100 may control the vehicle to maintain a current speed and a current lane, when it is impossible to change the current lane to the left lane in a state where there is a high-speed approaching vehicle behind the reference vehicle or the rear vehicle is driving while blinking a head lamp in operation S401.

In operation S407, the vehicle driving control apparatus 100 determines whether it is possible to increase the speed of the reference vehicle when it is impossible to change the current lane to the left lane in a state where a heavy duty truck or a heavy duty bus is driving behind the reference vehicle in operation S401. The vehicle driving control apparatus 100 may determine whether it is possible to increase a vehicle speed by determining whether there is a front vehicle, the relative speed and the relative distance of the front vehicle, the intent of a lane change of the front vehicle, or the like. For example, the vehicle driving control apparatus 100 may stop the control of a speed increase by determining that the intent of a lane change is present when a front vehicle in a left or a right lane of a lane in which the reference vehicle is driving blinks a turn signal. That is, the vehicle driving control apparatus 100 may stop the control of a speed increase of the reference vehicle when the front vehicle in a left or right lane blinks a turn signal to change the current lane to the lane in which the reference vehicle is driving.

In operation S408, the vehicle driving control apparatus 100 determines that it is possible to increase the speed of the reference vehicle and controls the reference vehicle to increase the speed of the reference vehicle when the speed of the front vehicle of the reference vehicle is not less than the speed of the rear vehicle of the reference vehicle.

As such, in operation S408, the vehicle driving control apparatus 100 may control the reference vehicle to increase the speed of the reference vehicle. In operation S409, the vehicle driving control apparatus 100 may control the reference vehicle to maintain the current speed and the current driving lane of the reference vehicle when it is impossible to increase the speed of the reference vehicle.

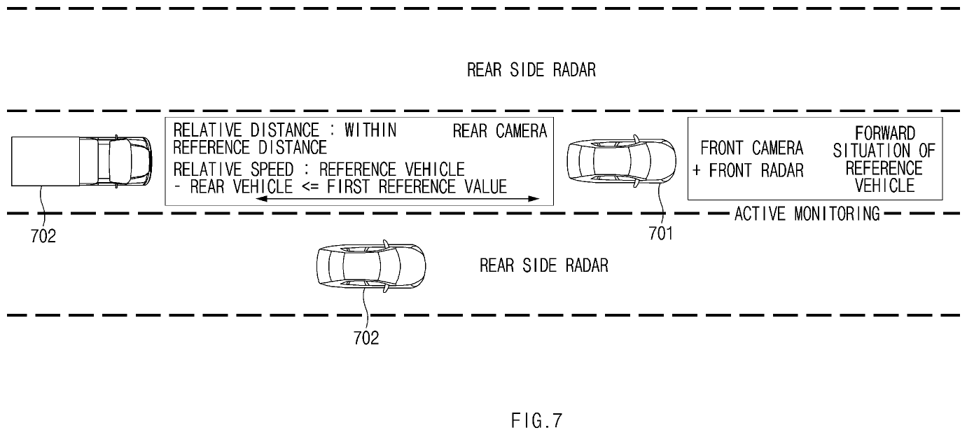

FIG. 7 is a view for describing an operation to control an automatic lane change to a left lane when a lane change is necessary upon driving a middle lane, according to an embodiment of the present disclosure.

After controlling a reference vehicle 701 to change the current lane to the first lane or the third lane, the vehicle driving control apparatus 100 may perform return control to the second lane, which is the original lane, when the reference vehicle 701 is driving on the second lane among three lanes, and/or when there is a large vehicle 702 behind the reference vehicle.

After controlling the lane change to the third lane, which is a slow lane, the vehicle driving control apparatus 100 may perform return control to the second lane, which is the original lane, because the change to the first lane, which is a passing lane, is impossible when there is a high-speed approaching vehicle or a head lamp blinking vehicle behind the reference vehicle.

Moreover, the vehicle driving control apparatus 100 may determine whether a lane change is necessary by monitoring whether there is a heavy duty bus or a heavy duty truck or the relative speed or the relative distance of the heavy duty bus or the heavy duty truck. That is, the vehicle driving control apparatus 100 may determine that the lane change is necessary when a heavy duty bus or a heavy duty truck is present within a reference distance from the reference vehicle 701, when a difference between the speed of the heavy duty bus or the heavy duty truck and the speed of the reference vehicle 701 is not greater than a predetermined reference value (e.g., −1 km/h), or when a rear vehicle does not blink a turn signal and does not have the intent of a lane change (e.g., there is no blink of a turn signal).

The vehicle driving control apparatus 100 may determine whether the lane change is possible by monitoring left-side and right-side rear situations of the reference vehicle. The vehicle driving control apparatus 100 may determine whether it is possible to change the current lane to the right lane by monitoring the relative speed of the right rear vehicle 702 when the right rear vehicle 702 is present. In FIG. 7, because there is no rear vehicle on the left rear side, the vehicle driving control apparatus 100 may control the reference vehicle 701 to change the current lane to the left lane.

Next, the vehicle driving control apparatus 100 may perform return control to the second lane, which is the previous lane, through a rear side radar, a rear camera, a front camera, or a front radar in consideration of the location of a reference vehicle, whether the rear side or front vehicle is present, and the relative speeds and the relative distances of a left-side or a right-side rear vehicle and the front vehicle. The relative distance may indicate a distance value obtained by subtracting the location of the reference vehicle from the location of the left-side or the right-side rear vehicle or the front vehicle. The vehicle driving control apparatus 100 may return control to the previous lane when the relative distance is not less than a reference distance from the reference vehicle and a relative speed is not less than 0 km/h.

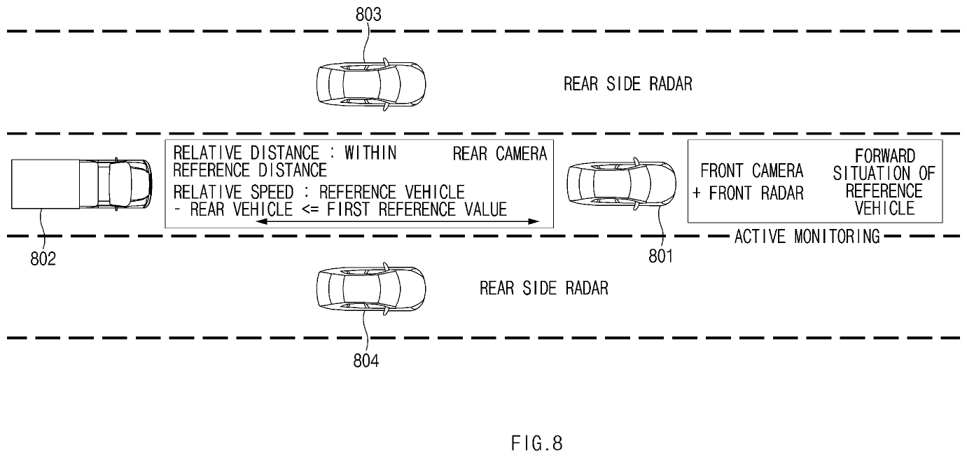

FIG. 8 is a view for describing an operation to control a vehicle speed when it is impossible to change the current lane to a left lane and a right lane when a lane change is necessary upon driving a middle lane, according to an embodiment of the present disclosure. The vehicle driving control apparatus 100 recognizes a lane in which a reference vehicle is driving. An embodiment includes the reference vehicle driving in the second lane of three lanes.

After controlling the lane change to the first lane or the third lane, the vehicle driving control apparatus 100 may perform return control to the second lane, which is the previous lane, when there is a large vehicle 802 behind a reference vehicle 801. The vehicle driving control apparatus 100 may determine whether the lane change is necessary depending on whether there is a large vehicle behind the reference vehicle and the relative distance and the relative speed of the large vehicle.

That is, the vehicle driving control apparatus 100 may determine that the lane change is necessary when the heavy duty truck or the heavy duty bus is present behind the reference vehicle within a reference distance from the reference vehicle, when a relative speed is not greater than a predetermined reference value (e.g., −1 km/h) based on the reference vehicle, or when the rear vehicle does not blink a turn signal and does not have the intent of the lane change.

Next, the vehicle driving control apparatus 100 may determine whether the lane change is possible by monitoring a left/right rear situation of the reference vehicle. The lane change is impossible because there is a left rear vehicle 803 and a right rear vehicle 804 in FIG. 8. However, the vehicle driving control apparatus 100 may perform lane change in consideration of the relative distance and the relative speed of the left rear vehicle 803 and the right rear vehicle 804.

Moreover, the vehicle driving control apparatus 100 may monitor the forward situation of the reference vehicle to determine whether vehicle speed control is possible when the lane change is impossible. That is, the vehicle driving control apparatus 100 may determine whether there is a left or a right lane vehicle in front of the reference vehicle. The vehicle driving control apparatus 100 may determine that the increase in a vehicle speed is possible when there is no front vehicle in the left or the right lane. Furthermore, the vehicle driving control apparatus 100 may determine that the increase in a vehicle speed is impossible when it is determined that the front vehicle in a left/right lane intends to change the current lane to a lane in which the reference vehicle is driving (e.g., the front vehicle blinks a turn signal). The vehicle driving control apparatus 100 may determine that the front vehicle in the left lane has the intent of the lane change to the lane in which the reference vehicle is driving when the front vehicle on the left lane blinks a right turn signal. The vehicle driving control apparatus 100 may determine that the front vehicle in the right lane has the intent of the lane change to the lane in which the reference vehicle is driving when the front vehicle on the right lane blinks a left turn signal.

In addition, the vehicle driving control apparatus 100 may determine that it is possible to control the increase of a vehicle speed by determining a relative speed and a relative distance between the front vehicle and the reference vehicle when the relative speed (e.g., the speed of the reference vehicle−the speed of the front vehicle) is not greater than a predetermined speed or when the relative distance is not less than 30 m.

Furthermore, the vehicle driving control apparatus 100 may control the increase in a speed when the relative speed of the front vehicle based on the reference vehicle is not less than the relative speed of the rear vehicle based on the reference vehicle. The vehicle driving control apparatus 100 may control the increase in a speed until the speed of the reference vehicle reaches the speed of the rear vehicle.

Moreover, the vehicle driving control apparatus 100 maintains a current speed, i.e., not increases a vehicle speed, when the relative speed of the front vehicle based on the reference vehicle is less than the relative speed of the rear vehicle based on the reference vehicle.

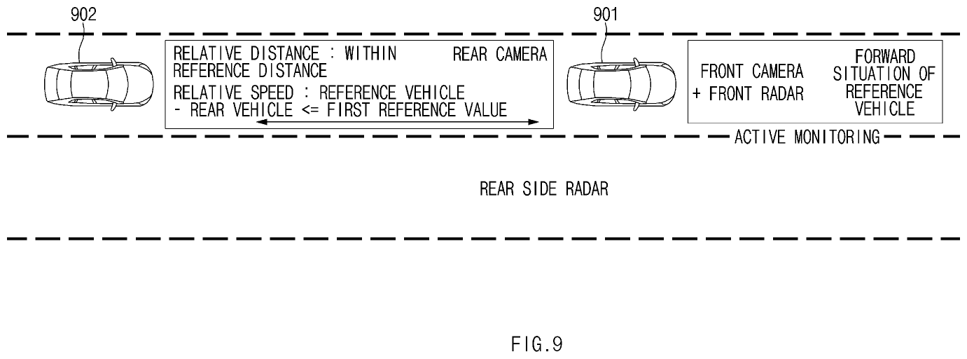

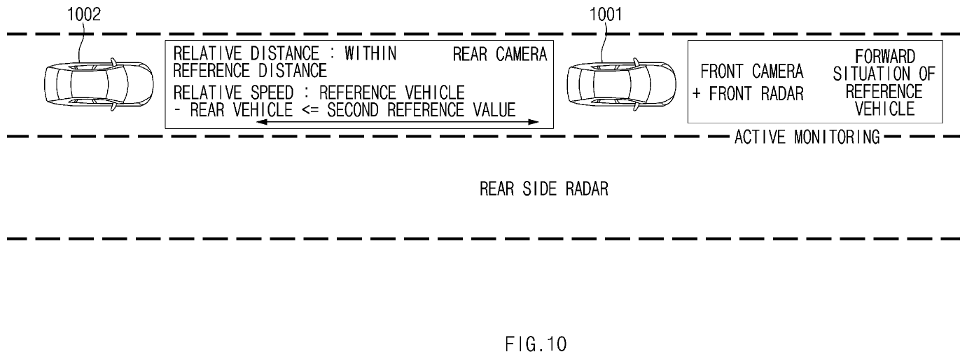

FIG. 9 is a view for describing an operation to control an automatic lane change when a rear vehicle is approaching with a head lamp blinking while driving a passing lane, according to an embodiment of the present disclosure. FIG. 10 is a view for describing an operation to control an automatic lane change when a rear vehicle is approaching at high speed while driving in a passing lane, according to an embodiment of the present disclosure.

The vehicle driving control apparatus 100 may determine that a reference vehicle 901 or 1001 is driving in the first lane among two lanes. The vehicle driving control apparatus 100 may determine that a lane change is necessary when a vehicle 902 blinking a head lamp or a vehicle 1002 driving at high speed is approaching behind the reference vehicle.

The vehicle driving control apparatus 100 may determine that the lane change is necessary by monitoring the relative speed and the relative distance of the vehicle 902 blinking a head lamp or the vehicle 1002 driving at high speed. The vehicle driving control apparatus 100 may determine that the lane change is necessary when the vehicle 902 blinking a head lamp or the vehicle 1002 driving at high speed is within a reference distance from the reference vehicle 901 or 1001 or when the relative speed (the relative speed of the reference vehicle—the relative speed of the rear vehicle) is not greater than a second reference value and when the rear vehicle does not blink a turn signal or does not have the intent of the lane change.

The vehicle driving control apparatus 100 determines whether a lane change is possible by monitoring a left-side or a right-side rear situation of the reference vehicle. The vehicle driving control apparatus 100 determines that a lane change is possible when there is no right rear vehicle or when the relative speed and the relative distance of the right rear vehicle is not less than a predetermined value.

The vehicle driving control apparatus 100 may determine whether the front vehicle and the rear vehicle are present through a rear side radar, a rear camera, a front camera, and a front radar. The vehicle driving control apparatus 100 may determine whether return control to the previous lane is performed based on the front vehicle and the rear vehicle in consideration of the relative speed and the relative distance based on the reference vehicle. That is, the vehicle driving control apparatus 100 may perform return control to the original lane when a relative distance (the relative distance of the reference vehicle−the relative distance of the front vehicle or the rear vehicle) is not less than a front reference distance or when a relative speed (the speed of the reference vehicle−the speed of the front vehicle or the rear vehicle) is not less than 0 km/h.

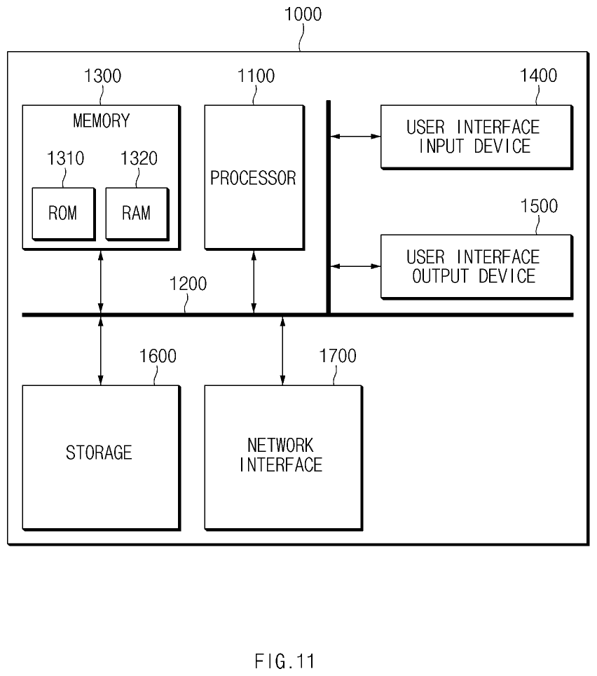

FIG. 11 illustrates a computing system according to an embodiment of the present disclosure.

Referring to FIG. 11, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Thus, the operations of the methods or algorithms described in connection with the embodiments disclosed in the specification may be directly implemented with a hardware module, a software module, or a combination of the hardware module and the software module, which is executed by the processor 1100. The software module may reside on a storage medium (e.g., the memory 1300 and/or the storage 1600) such as a RAM, a flash memory, a ROM, an erasable and programmable ROM (EPROM), an electrically EPROM (EEPROM), a register, a hard disc, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

Hereinabove, although the present disclosure has been described with reference to embodiments and the accompanying drawings, the present disclosure is not limited thereto but may be variously modified and altered by those having ordinary skill in the art to which the present disclosure pertains without departing from the spirit and scope of the present disclosure claimed in the following claims.

Therefore, embodiments of the present disclosure are not intended to limit the technical spirit of the present disclosure but provided only for an illustrative purpose. The scope of protection of the present disclosure should be construed by the attached claims, and all equivalents thereof should be construed as being included within the scope of the present disclosure.

This technology may automatically change the driving lane by determining whether a lane change is necessary through monitoring a rear lane, thereby increasing the reliability of a system and the convenience of a user.

A variety of effects directly or indirectly understood through this disclosure may be provided.

What is claimed is:

1. An apparatus for controlling driving of a vehicle, the apparatus comprising:
a processor, wherein the processor is configured to:
determine whether a lane change is necessary based on a rear situation of a reference vehicle;
when the lane change is necessary, determine whether the lane change is possible based on a left-side rear situation and a right-side rear situation of the reference vehicle; and
perform lane change control depending on the determination result; and
a storage configured to store a result of monitoring the rear situation, the left-side rear situation, and the right-side rear situation of the reference vehicle.

2. The apparatus of claim 1, wherein the processor is configured to:
when the lane change is impossible, monitor a forward situation of the reference vehicle to determine whether vehicle speed control of the reference vehicle is possible; and
perform the vehicle speed control of the reference vehicle.

3. The apparatus of claim 1, wherein the processor is configured to:
determine that the lane change is necessary when at least one or more of a large vehicle, a high-speed approaching vehicle, and a vehicle blinking a head lamp are present behind the reference vehicle.

4. The apparatus of claim 1, wherein the processor is configured to:
determine whether the lane change is necessary, depending on at least one or more of:
a relative distance of a large vehicle, a high-speed approaching vehicle, and a vehicle blinking a head lamp, which are present behind the reference vehicle;
a relative speed of the large vehicle, the high-speed approaching vehicle, and the vehicle blinking the head lamp; and
whether the large vehicle, the high-speed approaching vehicle, and the vehicle blinking the head lamp blink a turn signal.

5. The apparatus of claim 1, wherein the processor is configured to determine whether the lane change is possible, depending on whether there is a rear vehicle driving in a rear left lane of the reference vehicle or a rear right lane of the reference vehicle.

6. The apparatus of claim 1, wherein the processor is configured to determine a lane in which the reference vehicle is driving.

7. The apparatus of claim 6, wherein the processor is configured to:
when the reference vehicle is driving in a passing lane, determine whether the lane change to a right lane is possible; and
when the lane change to the right lane is possible, perform the lane change to the right lane.

8. The apparatus of claim 7, wherein the processor is configured to, when it is impossible for the reference vehicle to change to the right lane and when a rear vehicle is a large vehicle, monitor a forward situation of the reference vehicle to determine whether an increase in a vehicle speed is possible.

9. The apparatus of claim 8, wherein the processor is configured to determine that the increase in the vehicle speed is possible, in at least one or more cases of:
a case where there is no front vehicle of the reference vehicle;
a case where the front vehicle is present but a relative speed and a relative distance of the front vehicle satisfy a reference condition, and
a case where the front vehicle is present but the front vehicle does not have an intent of a lane change to the lane of the reference vehicle.

10. The apparatus of claim 7, wherein the processor is configured to, when it is impossible for the reference vehicle to change to the right lane and when a rear vehicle is a high-speed approaching vehicle or a vehicle blinking a head lamp, allow a current speed and a current lane to be maintained.

11. The apparatus of claim 6, wherein the processor is configured to, when the reference vehicle is driving in a slow lane among a plurality of lanes and when there is a large vehicle behind on the lane in which the reference vehicle is driving, or when a relative speed or a relative distance of the large vehicle satisfies a predetermined condition and there is no blink of a turn signal, determine that the lane change is necessary.

12. The apparatus of claim 11, wherein the processor is configured to:
when the lane change is necessary, determine whether a change to a left lane is possible; and
when the change to the left lane is impossible, determine whether to increase a vehicle speed.

13. The apparatus of claim 6, wherein the processor is configured to:
when the reference vehicle is driving in a middle lane among a plurality of lanes, determine whether the lane change to a right lane is possible, and
when the lane change to the right lane is not possible, determine whether an increase in a vehicle speed is possible.

14. The apparatus of claim 1, wherein the processor is configured to, after controlling the lane change, monitor a forward situation and the rear situation on a changed lane to perform return control to a previous lane.

15. A vehicle system comprising:
a vehicle driving control apparatus, wherein the vehicle driving control apparatus is configured to:
determine whether a lane change is necessary based on a rear situation of a reference vehicle;
when the lane change is necessary, determine whether the lane change is possible based on a left-side rear situation and a right-side rear situation of the reference vehicle; and
perform lane change control depending on the determination result; and
a sensing module, wherein the sensing module is configured to:
sense a surrounding situation of the reference vehicle to transmit the sensing result to the vehicle driving control apparatus.

16. A method for controlling a driving of a vehicle, the method comprising:
monitoring a rear situation of a driving reference vehicle, which is driving, to determine whether a lane change is necessary;
when the lane change is necessary, monitoring a left-side rear situation and a right-side rear situation of the reference vehicle to determine whether the lane change is possible; and
when the lane change is possible, performing lane change control.

17. The method of claim 16, further comprising:
when the lane change is impossible, monitoring a forward situation of the reference vehicle to determine whether vehicle speed control is possible; and
when the vehicle speed control is possible, performing the vehicle speed control of the reference vehicle.

18. The method of claim 16, further comprising:
after controlling the lane change, monitoring a forward situation and the rear situation in a changed lane to perform return control to a previous lane.

19. The method of claim 16, wherein the determining of whether the lane change is necessary includes:
when at least one or more of a large vehicle, a high-speed approaching vehicle, and a vehicle blinking a head lamp are present behind the reference vehicle, determining that the lane change is necessary.

20. The method of claim 16, wherein the determining of whether the lane change is necessary includes:
determining whether the lane change is necessary depending on at least one or more of:
a relative distance of a large vehicle, a high-speed approaching vehicle, and a vehicle blinking a head lamp, which are present behind the reference vehicle;
a relative speed of the large vehicle, the high-speed approaching vehicle, and the vehicle blinking the head lamp; and
whether the large vehicle, the high-speed approaching vehicle, and the vehicle blinking the head lamp blink a turn signal.
